(19) United States
(12) Patent Application Publication
(10) Pub. No.: US 2009/0033630 A1
(43) Pub. Date: Feb. 5, 2009

(54) HAND-HELD DEVICE FOR CONTENT NAVIGATION BY A USER

(75) Inventor: Eric Thelen, Aachen (DE)

Correspondence Address: AHS INC, 2234 ROAD 181, CHAPPELL, NE, 69129, US

(73) Assignee: KONINKLIJKE PHILIPS ELECTRONICS, N.V., EINDHOVEN (NL)

(21) Appl. No.: 11/569,773

(22) PCT Filed: May 24, 2005
(86) PCT No.: PCT/IB2005/051686

§ 371 Date: Aug. 22, 2007

(30) Foreign Application Priority Data
Jun. 4, 2004 (EP) 04102512.3

(51) Int. Cl. G09G 5/00; G06F 3/041

(52) U.S. Cl. 345/173; 345/156

(57) ABSTRACT

This invention relates to a hand-held device (100,200) and a method for content navigation by a user (102). A ball shaped housing (101) having a display area (103) enables a display of information (105) on the surface of the device. To determine the absolute or relative position and/or an absolute or relative orientation of said device (100,200) one or more sensors (402) are used. Based on the sensor data, the change in the absolute or relative position and/or an absolute or relative orientation of said device (100,200) is determined and correlated to the display of information on said at least one display area (103).

This invention relates to a hand-held device and a method for content navigation by a user, the device having a substantially ball shaped housing comprising at least one display area for enabling a display of information. By using one or more sensors the position and/or the relative orientation of the hand-held device are determined and used to correlate the content that the user is navigating.

Various computer input devices have been designed to allow user manipulation of graphical pointers, cursors or objects on the computer screen in two dimensions. The most common is the computer mouse, which is used to navigate a very well defined navigation plane, where the movement of the mouse is detected by a ball. In some application scenarios the navigation plane of the traditional mouse is extended by an automatic scrolling function, which adds one additional degree of freedom to the traditional mouse. A general limitation of mouse-based interaction is the restriction to the desktop navigation space. Since the mouse movement is directional and involves a physical change of location of the interaction device (the mouse), physical boundaries for such a type of control device exist. This limits the interaction area and causes inconvenience, e.g. when the mouse has to be manually picked up in order to modify its physical location without changing the position of the pointer on the screen. This is especially problematic when there is a need for browsing a large amount of information items, e.g. a list of songs stored in an archive. It is a challenge for traditional user interface devices to conveniently browse such large content spaces. In the last years there has been some development in input devices. One is described in U.S. Pat. No. 5,923,318, which presents a six degrees of freedom input device, which provides a fast navigation. In this device the entire housing is provided with a pressure sensitive switch, which is activated by a user squeezing the housing. Although this input device provides a fast navigation it has the same drawback as in other input devices, being that during navigation the user has to stay in a proximity to the electrical device that the input device is connected to (e.g. the computer) in order to be able to observe the navigation. A further problem is that the interaction between the user and the device is restricted by squeezing the housing. This can affect the user physically over a long time period.

It is an object of the present invention to solve the above mentioned problems of the prior art among others.

Another object is to provide a hand-held device allowing easy and intuitive navigation.

In one aspect this is achieved by a hand-held device for content navigation by a user comprising:
a substantially ball shaped housing comprising at least one display area for enabling a display of information,
at least one sensor for determining an absolute or relative position and/or an absolute or relative orientation of said device resulting in output data, and
a transmitter for transmitting said output data or for transmitting processed data being processed on the basis of said output data,

where the device is adapted to correlate the change in the absolute or relative position and/or an absolute or relative orientation of said device to the content that the user is navigating based on said transmitted data.

Thereby, a device that is intuitive and easy to use is provided where the user can perform a content navigation by monitoring the display of said information on said display area of the hand-held device and is therefore not forced to stay in a proximity to the device during navigation.

In one embodiment the device further comprises a receiver for receiving and displaying said information in said display area. Said information may comprise “virtual” information, i.e. information that is simultaneously being displayed on an external device. Thereby, the electrical device or devices that the hand-held device is connected to can transmit information to the hand-held device, said information being received by said receiver and displayed as virtual information during content navigation.

In one embodiment the hand-held device further comprises a user interface for user interaction with one or more electronic devices. Therefore, in addition to the already described navigation feature, the hand-held device provides a direct feedback with said one or more electronic devices that the hand-held device may be interconnected to. As an example of devices that the user can be interconnected to is a computer or a TV. In the former case, the hand-held device would have a similar function as a computer mouse comprising as an example left and right touch-sensitive buttons. In the latter case, the hand-held device can have a similar function as a TV remote controller, where it could comprises a touch-sensitive surface having a user interface corresponding to the user interface of a remote controller. The connection between said hand-held device and said one or more devices can be realized via wireless communication, such as wireless local area network (WLAN) or a communication protocol such as Bluetooth. Other types of communication or communication protocols are inherently also possible.

In one embodiment the user interface comprises at least one from the group consisting of:
buttons on the surface of the device,
touch-sensitive surface on the display surface,
means for registering shaking or squeezing of the device,
speech interface, and
separate interaction device such as remote control.

Therefore, a convenient user interface is possible, depending on the user demands.

The substantially ball shaped housing of the hand-held device comprises in one embodiment a spherical or elliptical shaped housing or the like which enables rolling, tilting movements. Having such a shape of the housing, the movement is not limited to any physical constraints, so the device has six degrees of freedom and therefore enables a fast and comfortable content navigation. The navigation of the device is obtained e.g. through moving, turning, tilting, spinning or rolling the device.

In one embodiment said at least one display area comprises a single display area covering substantially the entire ball shaped housing. This has the advantage that a larger display area may be monitored simultaneously. The display area may comprise LCD or LED's or the like for enabling a display of said information on the surface of the hand-held device. In another embodiment said at least one display area comprises a single “active” display area having boundaries, so that the information is displayed at a predetermined relative position on the device. As an example, the display area may always be on the top or always on a certain position just below the top. Therefore, if the device is e.g. rolled in one direction, the displayed information is rolled in an opposite direction to maintain the visual display within said display area. This has the advantage that the illumination from the device is less than if the whole surface area of the hand-held device is used as a display area. In one preferred embodiment the device provides the ability to switch between said single display area covering the whole substantially ball shaped housing and said “active” display area having boundaries, and vice verse.

In one embodiment the hand-held device further comprises one or more portable electrical devices integrated into the device. Accordingly, in addition to the before mentioned features, the device may e.g. comprise an MP3 player, a palm pilot or any kind of portable electronic equipment, where the surface of the device is used as a user interface. This enhances the multiplicity of the device.

In another aspect this invention relates to a method for navigating content by a user by using a hand-held device having a substantially ball shaped housing with at least one display area for enabling a display of information, the method comprising the steps of:
determining an absolute or relative position and/or an absolute or relative orientation of said device resulting in output data, and
transmitting said output data or for transmitting processed data being processed on the basis of said output data,

where the device is adapted to correlate the change in the absolute or relative position and/or an absolute or relative orientation of said device to the content that the user is navigating based on said transmitted data.

Thereby, the user can perform a fast content navigation by monitoring the display of information on said display area without being forced to stay in a proximity to the device during navigation. In one embodiment the content that the user is navigating corresponds to the display of information in the display area. In another embodiment the display of information in said at least one display area comprises virtual information from one or more external electronic devices.

In a third aspect, the present invention relates to a computer readable medium having stored therein instructions for causing a processing unit to execute the before mentioned method.

In the following the present invention, and in particular preferred embodiments thereof, will be described in more details in connection with accompanying drawings in which

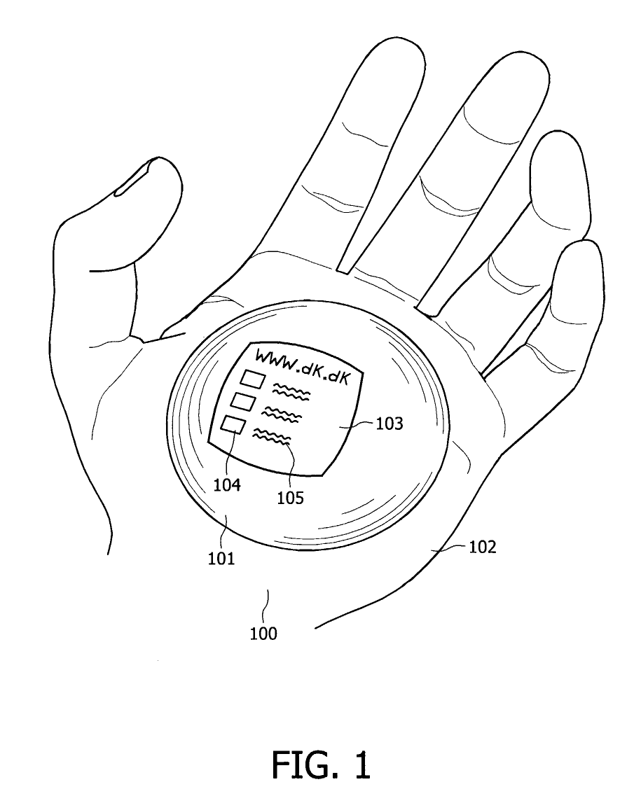

FIG. 1 shows a hand-held device according to the present invention placed in a hand of a user for content navigation by said user,

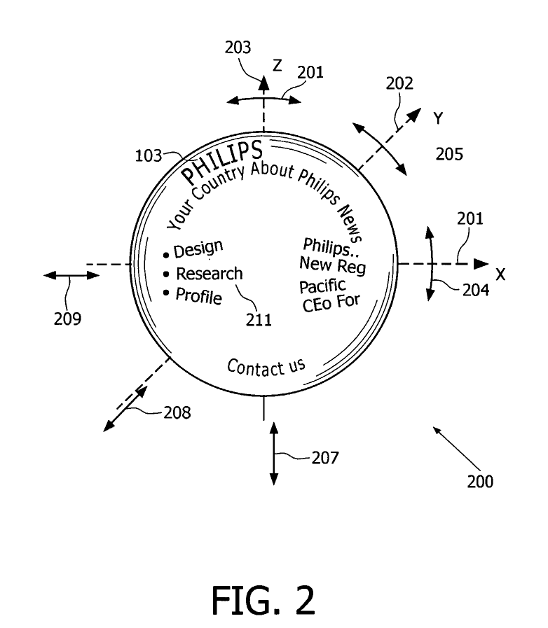

FIG. 2 shows another embodiment of the hand-held device,

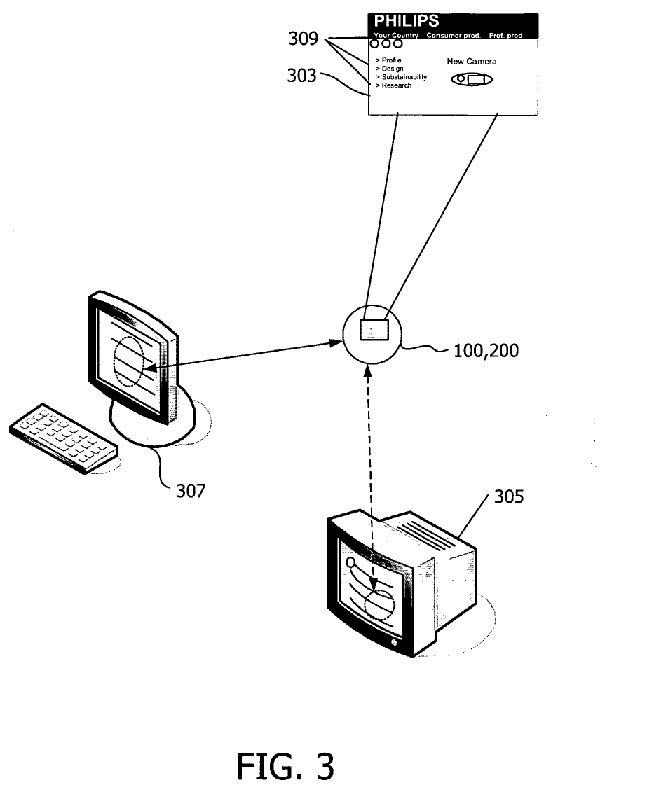

FIG. 3 shows one embodiment of the hand-held device, wherein, besides from u-sing the device as a virtual desktop, the device further comprises an interacting means for providing at least one user interaction with one or more devices in the environment,

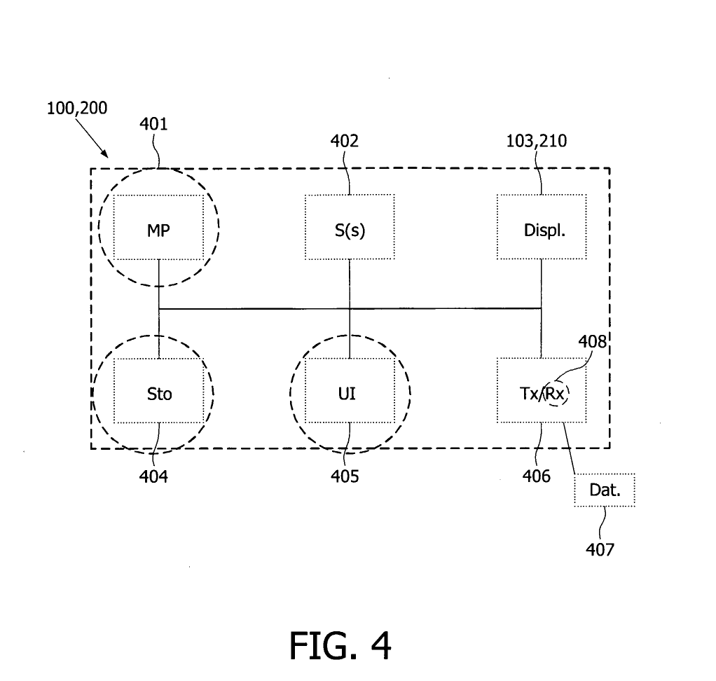

FIG. 4 shows a flowchart describing the steps in content navigating by a user by means of a hand-held device, and

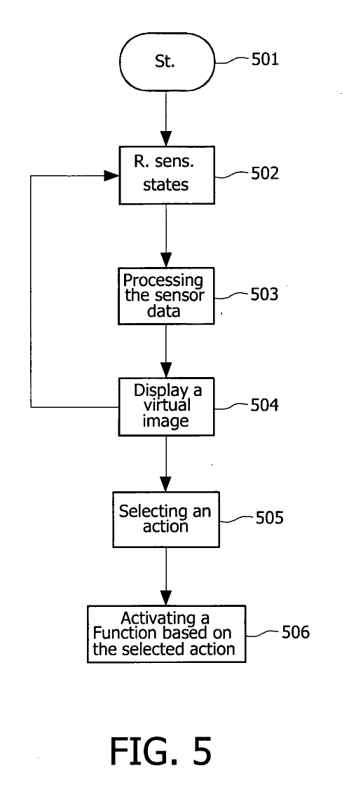

FIG. 5 shows a flowchart describing the same steps as shown in FIG. 4, where the device is turned on and sensors detect the movement and relative positioning of the device.

FIG. 1 shows a hand-held device 100 according to the present invention placed in a hand 102 of a user for content navigation by said user. The hand-held device 100 has a substantially ball shaped housing 101 comprising at least one display area 103 for enabling a display of information 105, at least one sensor for determining an absolute or relative position and/or an absolute or relative orientation of said device 100 resulting in output data and a transmitter that transmits said output data or processed data on the basis of the output data. It follows that the change in the absolute or relative position and/or an absolute or relative orientation of said device 100 is correlated to the content that the user is navigating.

In one embodiment the information comprises additional “virtual” information, as is explained in more details in the following, based on transmitted information from one or more external electrical devices. In this embodiment the hand-held device 100 is provided with a receiver for receiving said transmitted information. In another embodiment, the displayed information 105 comprises information that is stored within the hand-held device 100 in storage means that could be integrated into the device 100.

The display area 103 may comprise LCD or LED's or the like for enabling a displaying of said information 105 on said display area 103. The connection between the hand-held device 100 and the one or more external electrical devices is preferably via wireless communication, such as wireless local area network (WLAN) or a communication protocol such as Bluetooth. Other types of communication or communication protocols are inherently also possible. In the embodiment shown in FIG. 1, an image is displayed on a display area 103 at a certain relative position on the device, e.g. always on the top or always on a certain position just below the top seen from the user. Therefore, if the hand-held device 100 is e.g. rolled in one direction, the displayed information is rolled in an opposite direction to maintain the position of the fixed display area 103.

The navigation of the hand-held device 100 is in one preferred embodiment obtained e.g. through moving, turning, tilting, spinning or rolling the hand-held device 100. Accordingly, to allow a fast navigation, the substantially ball shaped housing 101 comprises preferably a spherical or elliptical shaped housing or the like. In another embodiment the navigation could also be realized through direction buttons displayed on the display area 103 (up, down, left, right).

The sensor may e.g. be an accelerometer to detect horizontal and vertical movements of the hand-held device 100, a rotation sensor to detect spinning movements of the hand-held device 100 and a gravity sensor to detect the location of the top and bottom of the ball of the hand-held device 100. In one embodiment the sensors output data, which are transmitted to a processor, which may be situated in an external electronic device, e.g. in a Laptop computer, a PC computer, a TV, a DVD player or any type of electrical device that comprises a processor. The transmitted output data are processed and used to correlate the display of the information 105 to the absolute or relative position and/or an absolute or relative orientation of said hand-held device 100. Preferably, the display of information in the display area 103 is automatically scrolled to follow the change in the position. Due to the substantially ball shape housing 101 and the fact that the movement of the hand-held device 100 is not limited by any physical constraints, the hand-held device 100 can cover a very large virtual plane and therefore allow a fast navigation.

In one embodiment said processor is situated in the hand-held device 100 and the output data from the sensors are processed on the basis of said output data and subsequently transmitted to the externally situated electronic devices. The transmitted processed output data are then correlated to the display of said information 105, so that the display area 103 is automatically scrolled to follow the change in the position. Processing the information may comprise determining the absolute or relative position and/or an absolute or relative orientation of the hand-held device 100. In this way, processed data instead of “raw” data are transmitted.

In yet another embodiment the hand-held device 100 further comprises a user interface 104 for user interaction, where the user, in addition to the already described navigation features, can interact with on or more electronic devices. The user interaction can as an example take place via buttons 104 on the surface of the hand-held device 100, via a touch-sensitive surface on the display surface 104, via a specific movement of the hand-held device, via a speech interface or via a separate interaction device, such as a remote control. Any other kind of interaction mechanism is inherently also possible. The navigation feature may accordingly comprise scrolling the user interface, e.g. if the user interface does not fit within the display area 103, the user can through moving, turning, tilting, spinning or rolling the hand-held device 100 scroll the user interface. The selected interaction is then transmitted to an electronic device that the hand-held device 100 is interacting with, and based thereon one or more functions in said device can be activated. As an example, the user can be interconnected with a computer 307 as shown in FIG. 3, whereby the hand-held device 301 has a similar function as a computer mouse, whereby the traditional left and right mouse buttons could be the user interface.

In one embodiment an option for disabling the navigation features of the hand-held device 100 is implemented, e.g. in the form of “hold” switch, in order to avoid accidental interpretation of movements in situations, in which the hand-held device 100 is not in use.

FIG. 2 shows a hand-held device 200 as described in FIG. 1, except that here the whole surface of the device 200 is a display area 210. Since the movement of the hand-held device 200 is not limited to any physical constraints, the hand-held device has six degrees of freedom comprised in a linear movement indicated by the arrows 209, 208, 207 in the x, y, z directions 201,202, 203 and a rotational movement 204, 205, 201 around each of said axis. In this embodiment the hand-held device 200 could further comprise a user interface 211 as discussed before for user interaction 211, such as via a touch-sensitive surface on the display.

In one embodiment, and assuming that the displayed information 105 comprises a “virtual” information, the display area 103 or “virtual desktop” 103, 210 shown in FIGS. 1 and 2 may be implemented as a “virtual ball”. The model for navigation is then a ball (the hand-held device 100, 200), which is rolling on another, larger ball (not shown), which is the “virtual ball”. This means that there are no boundaries and that continuous navigation in one direction is possible. The size/diameter of the “virtual ball” is preferably adjustable according to the required size of the “virtual desktop”. Multiple “virtual desktops” could be arranged in hierarchical structures. The selection of a specific item on one “virtual desktop” could activate another “virtual desktop”, similarly to a directory or folder structure known from PC desktops.

FIG. 3 shows a hand-held device 100, 200 as described under FIGS. 1 or 2 that is interconnected to a computer 307 and also has the ability to e.g. be interconnected to a TV 305 and be used as a remote controller. When it is implemented as a remote controller, the surface of the hand-held device 100, 200 preferably comprises a user interface corresponding to the user interface of a remote controller. As shown in FIG. 3, the user has interconnected the hand-held device 100, 200 to the computer 307, and the user has entered a homepage 303, which is being displayed on the surface on the hand-held device 100, 200. By selecting one or more actions/functions 309, the user has the possibility of studying more details of the homepage 303. In a way, according to this example, the hand-held device 100, 200 can be used as a computer remote controller. As an additional feature, the hand-held device 100, 200 may further comprise a user interface corresponding to a keyboard, so that typing possibilities are provided.

In one embodiment the hand-held device (100,200) further comprises a storage means for storing information. The information can as an example be any type of data or information or be instructions for causing the processor to e.g. execute the processing of the output data from the sensors as discussed under FIGS. 1 and 2 and to display the received information on the surface of the housing (101).

In another embodiment the devices as described in FIGS. 1 and 2 100, 200 can additionally comprise one or more portable electrical devices integrated into the substantially ball-shaped housing. These could be an MP3 player, a PDA, or any kind of portable electronic equipment, where the surface of the hand-held device 100, 200 is used as a user interface. Accordingly, the hand-held device 100, 200 would additionally comprise the necessary plugs and preferably a modem, a network or the like to provide a connection to a communication channel such as the Internet.

FIG. 4 shows a block-diagram of a hand-held device 100,200 as described under FIGS. 1-3, showing a microprocessor 401, one or more sensors 402, display means 103, memory or storage means 404, a user interface 405 and a transmitter and/or a receiver 406. The microprocessor 401 can be situated externally in electronic devices 307, 305 (see FIG. 3) or in the hand-held device 100,200. The dotted circle illustrates the possibility of having the processor (and the other units within the dotted circles) situated externally from the hand-held device 100,200. The sensors 402 and the display 403 to be used in the hand-held device 100,200 can be of the type as discussed under FIGS. 1 and 2. If the hand-held device 100,200 further comprises one of said portable electrical devices, the microprocessor 402 can be the processor in said portable devices. The user interface 405 has the functionality as described under FIGS. 1-3, i.e. to enable the user to interact with other electrical devices or said portable devices that are integrated into the device. In one embodiment the hand-held device 100,200 comprises a transmitter and/or a receiver 406 for enabling a user interacting with other external devices and to receive information from said external devices.

FIG. 5 shows a flowchart describing the steps in using the device described in FIGS. 1-4. After turning the hand-held device at step 501, one or more sensors detect the absolute or relative position and/or an absolute or relative orientation of said hand-held device at step 502 and a processor processes the sensor's output data at step 503. As mentioned previously, the processor may be integrated into the hand-held device or may be located externally. Subsequently, the output data are correlated to the changes in the position and/or the orientation to the display of the received information at step 504. It follows that the display of information in the display area is automatically scrolled to follow the change in the position of the device. The flowchart shown here includes the steps where the hand-held device further comprises a user interaction with external electrical devices, where the user can select one or more action/functions at step 505, which activate one or more functions in said devices that are interconnected to the hand-held device at step 501.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word ‘comprising’ does not exclude the presence of other elements or steps than those listed in a claim. The invention can be implemented by means of hardware comprising several distinct elements, and by means of a suitably programmed computer. In a device claim enumerating several means, several of these means can be embodied by one and the same item of hardware. The mere fact that certain measures are recited in mutually different dependent claims does not indicate that a combination of these measures cannot be used to advantage.

1. A hand-held device (100,200) for content navigation by a user (102) comprising:
a substantially ball shaped housing (101) comprising at least one display area (103) for enabling a display of information (105),
at least one sensor (402) for determining an absolute or relative position and/or an absolute or relative orientation of said device (100,200) resulting in output data (407), and
a transmitter (406) for transmitting said output data (503) or for transmitting processed data being processed on the basis of said output data (503),
where the device is adapted to correlate the change in the absolute or relative position and/or an absolute or relative orientation of said device (100,200) to the content that the user is navigating based on said transmitted data (503).

2. A hand-held device (100,200) according to claim 1 further comprising a receiver (408) for receiving and displaying said information in said display area (103).

3. A hand-held device (100,200) according to claim 1, further comprising a user interface (211) for user interaction with one or more electronic devices (305,307).

4. A hand-held device (100,200) according to claim 3, wherein the user interface (211) comprises at least one from the group consisting of:
buttons (104) on the surface of the device,
touch-sensitive surface (211) on the display surface,
means for registering shaking or squeezing of the device,
speech interface, and
separate interaction device such as remote control.

5. A hand-held device (100,200) according to claim 1, wherein said at least one display area (103) comprises a single display area covering substantially the entire ball shaped housing (101).

6. A hand-held device (100,200) according to claim 1, wherein said at least one display area (103) comprises a single display area (103) where the information (105) is displayed at a predetermined relative position on the device (100,200).

7. A hand-held device (100,200) according to claim 1, further comprising one or more portable electrical devices integrated into the device (100,200).

8. A method for navigating content by a user (102) by using a hand-held device (100,200) having a substantially ball shaped housing (101) with at least one display area (103) for enabling a display of information, the method comprising the steps of:
determining an absolute or relative position and/or an absolute or relative orientation of said device (100,200) resulting in output data (407), and
transmitting said output data (503) or transmitting processed data being processed on the basis of said output data (503), where the device is adapted to correlate the change in the absolute or relative position and/or an absolute or relative orientation of said device (100,200) to the content that the user is navigating based on said transmitted data.

9. A method according to claim 8, wherein the content that the user is navigating corresponds to the display of information in the display area (103).

10. A method according to claim 8, wherein the display of information in said at least one display area (103) comprises information from one or more external electronic devices (305),(307).

11. A computer readable medium having stored therein instructions for causing a processing unit to execute the method of claim 8.
